(19) United States
(12) Patent Application Publication
(10) Pub. No.: US 2011/0288208 A1
(43) Pub. Date: Nov. 24, 2011

(54) MODIFIER FOR RESINS, ADHESIVE COMPOSITIONS, AND THERMOPLASTIC RESIN COMPOSITIONS

(76) Inventors: Takashi Nakatani, Osaka (JP); Takumi Okazaki, Osaka (JP)

(21) Appl. No.: 13/146,419

(22) PCT Filed: Mar. 11, 2010
(86) PCT No.: PCT/JP2010/054101

§ 371 Date: Jul. 27, 2011

(30) Foreign Application Priority Data
Mar. 13, 2009 (JP) 2009-060580
Mar. 31, 2009 (JP) 2009-083857

(51) Int. Cl. C09J 193/04; C09F 1/04

(52) U.S. Cl. 524/77; 530/215

(57) ABSTRACT

The present invention provides a resin modifier comprising as an active ingredient a hydrogenated rosin ester in which a component having a molecular weight of 320 of a methylation product of a hydrolyzate of the hydrogenated rosin ester as measured by gas chromatography-mass spectrometry accounts for 95 wt % or greater of the total amount of the components having a molecular weight of 314 to 320; a modifier that is an optical embrittlement inhibitor for use in an adhesive polymer resin; an adhesive composition comprising the optical embrittlement inhibitor; a modifier that is a melt fluidity and adhesion improver for a thermoplastic resin; and a thermoplastic resin composition comprising the melt fluidity and adhesion improver.

### TECHNICAL FIELD

The present invention relates to a modifier for various resins, an adhesive composition containing the modifier, and a thermoplastic resin composition containing the modifier.

### BACKGROUND ART

Rosin resins, petroleum resins, terpenic resins, and like resins having a low molecular weight of about 5,000 or less have been used as modifiers such as flow improvers, adhesion improvers, and tackifiers for various polymer resins. However, since such low molecular weight resins contain various impurities and have a double bond within the molecule, the resins absorb ultraviolet and other radiations and result in photo deterioration over time once added to polymer resins, and may not impart the originally desired modification effects to the polymer resins. In particular, for example, such resins bring about embrittlement of polymer resins that are used as adhesives, resulting in problems in that the tackiness and the adhesion strength of adhesive compositions are impaired.

To address the problems, such low molecular weight resins are subjected to hydrogenation or a like treatment to inhibit photo deterioration that occurs over time.

For example, Patent Literature 1 proposes a tackifier resin that is an esterification product of a rosin material containing about 50 wt % to about 91 wt % of tetrahydroabietic acid as a low molecular weight resin that can inhibit photo deterioration over time. Although the tackifier resin, once blended in a polymer resin, can inhibit to some extent embrittlement of an adhesive composition, exposure to ultraviolet radiation for a long period of time still results in embrittlement of the adhesive composition, thus resulting in a problem of impaired tackiness and adhesion.

Meanwhile, a photostabilizer is blended to improve the light resistance of polymer resins that are used in adhesives. However, use of a photostabilizer alone may result in insufficient light resistance and use of a photostabilizer in an excessive amount is likely to inhibit the effect of adding a low molecular weight resin or likely to adversely affect the physical properties of a polymer resin.

Effort has been made to add the aforementioned low molecular weight resin, as a modifier to improve melt fluidity and adhesion, to thermoplastic resins such as polystyrene resins, acrylic resins, and like vinyl resins, polycarbonate resins, olefin resins, polyester resins, and the like.

For example, Patent Literature 2 proposes a method for improving melt fluidity, moldability, or like properties by adding a hydrogenated terpenic resin to a styrene resin. Patent Literature 3 proposes a method for improving melt fluidity or like properties by adding a rosin or a rosin ester to an aromatic vinyl resin. However, although these methods can improve melt fluidity and other properties, the resin may become turbid during mixing depending on the type of thermoplastic resin. Moreover, there is a concern that these methods may adversely affect the resistance to light exposure.

### CITATION LIST

### Patent Literature

Patent Literature 1: JP 11-335654 A
Patent Literature 2: JP 04-370131 A
Patent Literature 3: JP 09-132687 A

### SUMMARY OF INVENTION

### Technical Problem

An object of the present invention is to provide a resin modifier that can significantly improve the properties of various resins such as adhesive polymer resins and thermoplastic resins.

Another object of the present invention is to provide a resin modifier, or an optical embrittlement inhibitor, that inhibits embrittlement of an adhesive polymer resin even when the resin is exposed to light irradiation and ultraviolet irradiation for a long period of time and that does not impair the effect of adding a low molecular weight resin, and also to provide an adhesive composition that contains the resin modifier and has excellent light resistance over time.

A still another object of the present invention is to provide a thermoplastic resin modifier that is sufficiently compatible with a broad range of thermoplastic resins, improves the melt fluidity and the adhesion of the thermoplastic resins, and imparts the thermoplastic resins an excellent initial color and transparency as well as excellent light resistance over time with which yellowing or a like phenomenon can be prevented even when the thermoplastic resins are exposed to light for a long period of time, and also to provide a thermoplastic resin composition containing the modifier.

### Solution to Problem

The inventors, having conducted extensive research to solve the problems described above, found that a hydrogenated rosin ester in which the amount of a specific component is controlled so as to be at a high level significantly improves the characteristics of various resins such as adhesive polymer resins and thermoplastic resins, and a resin composition that uses the hydrogenated rosin ester as a modifier demonstrates superior properties, thereby achieving the aforementioned objects. The inventors conducted further research based on the findings and have accomplished the present invention.

The present invention provides a resin modifier, an adhesive composition containing the modifier, and a thermoplastic resin composition containing the modifier as described below.

Item 1. A resin modifier comprising as an active ingredient a hydrogenated rosin ester in which a component having a molecular weight of 320 of a methylation product of a hydrolyzate of the hydrogenated rosin ester as measured by gas chromatography-mass spectrometry accounts for 95 wt % or greater of a total amount of components having a molecular weight of 314 to 320.

Item 2. The resin modifier according to item 1, wherein the hydrogenated rosin ester has a softening point of 60° C. to 120° C.

Item 3. The resin modifier according to item 1, wherein the hydrogenated rosin ester has a weight average molecular weight of 500 to 2,000.

Item 4. The resin modifier according to item 1, being an optical embrittlement inhibitor for use in an adhesive polymer resin.

Item 5. The resin modifier according to item 1, being a melt fluidity and adhesion improver for a thermoplastic resin.

Item 6. An adhesive composition comprising a polymer resin and an optical embrittlement inhibitor of item 4.

Item 7. The adhesive composition according to item 6, wherein the polymer resin is at least one resin selected from the group consisting of acrylic polymers, styrene/conjugated diene block copolymers, and olefin polymers.

Item 8. The adhesive composition according to item 7, wherein the polymer resin is an acrylic polymer.

Item 9. The adhesive composition according to item 6, wherein the optical embrittlement inhibitor is used in an amount of 2 to 210 parts by weight relative to 100 parts by weight of the polymer resin.

Item 10. The adhesive composition according to item 6, further comprising a tackifier.

Item 11. The adhesive composition according to item 10, wherein the tackifier is an esterified product of a hydrogenated rosin comprising 20 to 91 wt % of tetrahydroabietic acid.

Item 12. The adhesive composition according to item 10, wherein the optical embrittlement inhibitor is used in an amount of 20 to 500 parts by weight relative to 100 parts by weight of the tackifier.

Item 13. A thermoplastic resin composition comprising a thermoplastic resin and a melt fluidity and adhesion improver of item 5.

Item 14. The thermoplastic resin composition according to item 13, wherein the thermoplastic resin is at least one resin selected from the group consisting of thermoplastic vinyl resins, thermoplastic olefin resins, thermoplastic polycarbonate resins, and thermoplastic polyester resins.

Item 15. The thermoplastic resin composition according to item 13, wherein the melt fluidity and adhesion improver is used in an amount of 0.1 to 50 parts by weight relative to 100 parts by weight of the thermoplastic resin.

As used herein, the term “(meth)acrylic acid” refers to acrylic acid and methacrylic acid, and the term “(meth)acrylate” refers to acrylate and methacrylate.

### Advantageous Effects of Invention

According to the present invention, significant effects as described below are obtained.

(1) The resin modifier of the present invention in which the amount of a specific component is controlled so as to be at a high level can significantly improve the properties of various resins such as adhesive polymer resins and thermoplastic resins.

(2) The resin modifier of the present invention, which is an optical embrittlement inhibitor, exhibits excellent modification effects such as inhibiting embrittlement of a polymer resin even when the resin is exposed to light irradiation and ultraviolet irradiation for a long period of time and not impairing the effect of adding a low molecular weight resin.

(3) Accordingly, the optical embrittlement inhibitor of the present invention is preferable as a modifier for an adhesive composition to which a low molecular weight resin is added, and the adhesive composition that uses the optical embrittlement inhibitor exhibits excellent light resistance over time. Moreover, since the optical embrittlement inhibitor also has an adhesion improving effect, the optical embrittlement inhibitor is preferable as a modifier for an adhesive composition to which no low molecular weight resin is added. Furthermore, since the optical embrittlement inhibitor improves adhesion while maintaining the excellent light resisting properties of an acrylic polymer, the optical embrittlement inhibitor is particularly preferable as a modifier for an acrylic polymer adhesive composition.

(4) The thermoplastic resin modifier of the present invention, i.e., a melt fluidity and adhesion improver, is sufficiently compatible with a broad range of thermoplastic resins and exhibits excellent modification effects such as improving the melt fluidity and the adhesion of the thermoplastic resins. Accordingly, thermoplastic resins blended with the melt fluidity and adhesion improver of the present invention have an excellent initial color and transparency and is not likely to undergo yellowing or a like phenomenon even when the thermoplastic resins are exposed to light for a long period of time, i.e., have excellent light resistance over time.

(5) The thermoplastic resin modifier of the present invention is preferable as a modifier for a thermoplastic resin used in applications where light resistance is required over time. In particular, the modifier can be preferably used for thermoplastic vinyl resins, thermoplastic olefin resins, thermoplastic polycarbonate resins, thermoplastic polyester resins, and like resins.

### DESCRIPTION OF EMBODIMENTS

Resin Modifier

The resin modifier of the present invention contains a hydrogenated rosin ester as an active ingredient in which the amount of a specific component is controlled so as to be at a high level. That is, the resin modifier contains as an active ingredient a hydrogenated rosin ester characterized in that in the methylation product of the hydrolyzate of the hydrogenated rosin ester, the component having a molecular weight of 320 accounts for 95 wt % or greater of the total amount of the components having a molecular weight of 314 to 320, as determined by gas chromatography-mass spectrometry.

The resin modifier of the present invention can be preferably used as an optical embrittlement inhibitor for an adhesive polymer resin and as a melt fluidity and adhesion improver for a thermoplastic resin as stated above.

The active ingredient of the resin modifier is not particularly limited insofar as it is a hydrogenated rosin ester in which a component having a molecular weight of 320 of the methylation product of the hydrolyzate of the hydrogenated rosin ester as measured by gas chromatography-mass spectrometry accounts for 95 wt % or greater of the total amount of the components having a molecular weight of 314 to 320, and known materials can be used therefor. When the component having a molecular weight of 320 of the methylation product of the hydrolyzate thereof as measured by gas chromatography-mass spectrometry does not account for 95 wt % or greater of the total amount of the components having a molecular weight of 314 to 320, the effect of inhibiting embrittlement and yellowing caused by light irradiation or ultraviolet irradiation are not sufficiently exhibited.

As for the active ingredient of the resin modifier, the component having a molecular weight of 320 of the methylation product of the hydrolyzate corresponds to the methylation product of the rosin-derived resin acid component generated by hydrolysis, of which the unsaturated bonds within the molecule are all hydrogenated. The component having a molecular weight of 314 corresponds to the component having 3 carbon-carbon unsaturated bonds within the molecule. Therefore, the fact that the component having a molecular weight of 320 accounts for 95 wt % or greater of the total amount of the components having a molecular weight of 314 to 320 means that components having carbon-carbon unsaturated bond(s) contained in the modifier are very few.

The active ingredient of the resin modifier may be obtained by, for example, (1) subjecting a hydrogenated rosin (a1) in which the component having a molecular weight of 320 of a methylation product as measured by gas chromatography-mass spectrometry accounts for 95 wt % or greater of the total amount of the components having a molecular weight of 314 to 320 to an esterification reaction with an alcohol (b1) or a glycidyl group-containing compound (b2); or (2) subjecting a rosin (a2) in which the component having a molecular weight of 320 of a methylation product as measured by gas chromatography-mass spectrometry accounts for less than 95 wt % of the total amount of the components having a molecular weight of 314 to 320 to an esterification reaction with an alcohol (b1) or a glycidyl-group containing compound (b2) and then performing hydrogenation or a like operation so that the component having a molecular weight of 320 of a methylation product as measured by gas chromatography-mass spectrometry accounts for 95 wt % or greater of the total amount of the components having a molecular weight of 314 to 320.

For example, tetrahydroabietic acid may be used singly as the hydrogenated rosin (a1), or the hydrogenation rosin (a1) may be prepared by mixing tetrahydroabietic acid with a resin acid component such as abietic acid, and it may also be obtained by hydrogenating the rosin (a2) according to a method that will be described below such that the component having a molecular weight of 320 of a methylation product as measured by gas chromatography-mass spectrometry accounts for 95 wt % or greater of the total amount of the components having a molecular weight of 314 to 320. Tetrahydroabietic acid can be obtained according to a method as described in, for example, Journal of Organic Chemistry 31, 4128 (1966) or Journal of Organic Chemistry 34, 1550 (1969).

Examples of the rosin (a2) include wood rosin, tall oil rosin, gum rosin, and other natural rosins; disproportionated rosin and hydrogenated rosins except for the hydrogenated rosin (a1); and the like.

Specific examples of the alcohol (b1) include n-octyl alcohol, 2-ethylhexyl alcohol, decyl alcohol, lauryl alcohol, and like monohydric alcohols; ethylene glycol, diethylene glycol, propylene glycol, neopentyl glycol, cyclohexanedimethanol, and like dihydric alcohols; glycerol, trimethylolethane, trimethylolpropane, and like trihydric alcohols; pentaerythritol, diglycerol, and like tetrahydric alcohols; dipentaerythritol and like hexahydric alcohols; and the like. Any of these may be used singly or as a combination of two or more Examples of the glycidyl-group containing compound (b2) include glycidyl ethers, glycidols, and like those that form esters upon reaction with carboxylic acids. Any of these may be used singly or as a combination of two or more.

The proportion between the component (a1) or (a2) and the component (b1) or (b2) may be suitably determined according to, for example, the target acid value and hydroxyl value of the resulting reaction product. Usually, it is preferable that the molar ratio of the carboxyl group in the component (a1) or (a2) to the hydroxyl or glycidyl group in the component (b1) or (b2) is about 0.5 to about 2.

The esterification reaction may be performed according to a known esterification method. In particular, the esterification reaction is usually carried out under high-temperature conditions of about 150 to about 300° C. while removing generated water. Moreover, since the generated esterified product is likely to be colored if air is present during the esterification reaction, it is preferable to perform the reaction in inert gas such as nitrogen, helium, or argon. Although the reaction does not necessarily require an esterification catalyst, acetic acid, p-toluene sulfonic acid, or a like acid catalyst; calcium hydroxide or a like alkali metal hydroxide; or calcium oxide, magnesium oxide, or a like metal oxide may be used to shorten the reaction time.

A known method may be used to hydrogenate the reaction product obtained by the esterification reaction of the component (a2) and the component (b1) or (b2) as well as to hydrogenate the component (a2). Specifically, hydrogenation can be attained by, for example, heating the reaction product obtained by the esterification reaction of the component (a2) and the component (b1) or (b2) or heating the component (a2) in the presence of a hydrogenation catalyst under a hydrogen pressure of usually about 1 to about 25 MPa and preferably about 5 to about 20 MPa for a duration of usually about 0.5 to about 7 hours and preferably about 1 to about 5 hours at a temperature of usually about 100 to about 300° C. and preferably about 150 to about 290° C.

As for the hydrogenation catalyst, known hydrogenation catalysts can be used, for example, supported catalysts in which a metal such as palladium, rhodium, ruthenium, or platinum is supported on a carrier such as alumina, silica, diatomaceous earth, carbon, or titania; powder of metals such as palladium, rhodium, ruthenium, platinum, and nickel; iodine and iodides such as iron iodide; and the like. Among these examples, it is preferable to use a supported catalyst of a metal such as palladium, rhodium, ruthenium or platinum, or powder of such a metal because of their high hydrogenation efficiency (in particular, a favorable degree of hydrogenation, a short hydrogenation time). The amount of hydrogenation catalyst is usually about 0.01 to about 10 parts by weight and preferably about 0.01 to 5 parts by weight relative to 100 parts by weight of the reaction product obtained by the esterification reaction of the component (a2) and the component (b1) or (b2) or of the component (a2).

If necessary, the hydrogenation reaction may be carried out after dissolving the starting materials in a solvent. The solvent used is not particularly limited and may be a solvent in which the starting materials and the product readily dissolve. For example, cyclohexane, n-hexane, n-heptane, decalin, tetrahydrofuran, dioxane, and the like may be used singly or as a combination of two or more. The amount of solvent is not particularly limited and the solvent is usually used such that the solid content of the starting materials is about 10 wt % or greater. The amount of solvent is preferably in a range such that the solid content of the starting materials is about 10 to about 70 wt %.

In the case of a hydrogenated rosin ester that has been hydrogenated under ordinary hydrogenation conditions, the amount of the component having a molecular weight of 320 of the methylation product of the hydrolysate as measured by gas chromatography-mass spectrometry is increased to only about 20 wt % of the total amount of the components having a molecular weight of 314 to 320, and therefore, in order to obtain the active ingredient of the resin modifier of the present invention, it may be necessary to use severe hydrogenation conditions, for example, repeating hydrogenation and increasing the amount of catalyst or raising the hydrogenation temperature, or to specify a catalyst species.

The resin modifier of the present invention contains a hydrogenated rosin ester as an active ingredient in which the component having a molecular weight of 320 of the methylation product of the hydrolyzate as measured by gas chromatography-mass spectrometry accounts for 95 wt % or greater of the total amount of the components having a molecular weight of 314 to 320. The resin modifier may be composed solely of the active ingredient or may further contain various additives such as antioxidants, ultraviolet absorbers, and the like.

The hydrogenated rosin ester that is the active ingredient of the resin modifier of the present invention preferably has a softening point of about 60° C. to about 120° C. A softening point of about 60° C. or greater gives sufficient heat resistance, and a softening point of about 120° C. or less gives favorable compatibility when the hydrogenated rosin ester is used in a polymer resin. Also, the hydrogenated rosin ester, when used in a thermoplastic resin, enables enhancement in melt fluidity of a thermoplastic resin composition to be achieved.

The weight average molecular weight of the hydrogenated rosin ester that is the active ingredient of the resin modifier of the present invention is preferably about 500 to about 2,000 in terms of polystyrene as measured by gel permeation chromatography. A weight average molecular weight of about 500 or greater gives sufficient cohesion to a polymer resin; and a weight average molecular weight of about 2,000 or less gives sufficient melt fluidity to a thermoplastic resin and inhibits turbidity that can be generated during formulation irrespective of the type of thermoplastic resin.

Adhesive Composition

The adhesive composition of the present invention is a polymer resin formulated with the resin modifier, or the optical embrittlement inhibitor, of the present invention.

Herein, the adhesive composition encompasses pressure-sensitive adhesive compositions. Pressure-sensitive adhesives are a kind of adhesives that stick upon application of minimal pressure at ordinary temperature for a short period of time without water, a solvent, heat, or the like.

The adhesive composition is not particularly limited, and depending on the type of polymer resin, examples include acrylic polymer adhesive compositions, styrene/conjugated diene block copolymer adhesive compositions, olefin polymer hot-melt adhesive compositions, and the like. If necessary, known tackifiers may be used in these adhesive compositions.

In the adhesive composition, it is usually preferable that the amount of optical embrittlement inhibitor used is about 2 to about 210 parts by weight relative to 100 parts by weight of polymer resin. When the amount is less than 2 parts by weight, the optical embrittlement inhibitory effect is likely to be insufficient, and when the amount exceeds 210 parts by weight, adhesion performance such as cohesive force is likely to be impaired. Therefore, such amounts are not preferable.

If necessary, a known tackifier may be used in the adhesive composition. Examples of tackifiers include petroleum resins, rosin resins, terpenic resins, and like resins having a low molecular weight, e.g, a weight average molecular weight of about 5,000 or less. Examples of petroleum resins include C9 petroleum resins, C5 petroleum resins, dicyclopentadiene resins, hydrogenated products of these resins, and the like. Examples of rosin resins include rosins, disproportionated rosins, hydrogenated rosins, polymerized rosins, unsaturated acid-modified rosins, phenol-modified rosins; esterification products of these rosins with alcohols; and the like. As for the alcohols, it is preferable to use polyhydric alcohols such as glycerol and pentaerythritol. Examples of terpenic resins include terpene resins, terpene phenolic resins, hydrogenated products of these resins, and the like. As for the tackifiers, it is preferable to use esterification products of hydrogenated rosins containing about 20 to about 91 wt % of tetrahydroabietic acid in terms of significantly enhancing the effect of the light embrittlement inhibitor of the present invention. When a tackifier is used, the amount of optical embrittlement inhibitor used is not particularly limited, and it is usually preferable that the optical embrittlement inhibitor is used in an amount of about 20 to about 500 parts by weight and particularly preferably about 50 to about 200 parts by weight relative to 100 parts by weight of tackifier.

As for the adhesive polymer resin, it is preferable to use one or two or more acrylic polymers, styrene/conjugated diene block copolymers, olefin polymers, and the like.

The acrylic polymer adhesive composition that is an adhesive composition of the present invention comprises at least the light embrittlement inhibitor of the present invention and an acrylic polymer.

The makeup of an acrylic monomer used to obtain the acrylic polymer may be suitably arranged according to the use of the acrylic adhesive composition. Examples of such acrylic monomers include (meth)acrylates. Specific examples include methyl (meth)acrylate, ethyl (meth)acrylate, butyl (meth)acrylate, 2-ethylhexyl (meth)acrylate, and the like. With regard to crosslinkable acrylic monomers, for example, (meth)acrylic acid, glycidyl (meth)acrylate, 2-hydroxyethyl (meth)acrylate, N-methylol(meth)acrylamide, and the like may be used in combination with the aforementioned (meth)acrylates, and if desired, insofar as the adhesion properties of the (meth)acrylate polymer is not impaired, other copolymerizable monomers, for example, vinyl acetate, styrene, and the like may be used in combination. Meanwhile, as for the acrylic monomer, a polymerizable oligomer having an olefinic double bond that can be obtained by polymerizing at least one of the aforementioned monomers may also be used.

The method for polymerizing the acrylic monomer is not particularly limited, and known methods such as bulk polymerization, solution polymerization, dispersion polymerization, and emulsion polymerization can be employed. Also, the method for initiating polymerization can be suitably selected from known methods such as methods that use a thermal polymerization initiator such as benzoyl peroxide, lauroyl peroxide, azobisisobutyronitrile, potassium persulfate, or ammonium persulfate; methods that use ultraviolet irradiation and a photopolymerization initiator such as benzoin, benzoin methyl ether, or benzophenone; methods that use electron beam irradiation; methods that use a redox initiation system formed with a combination of a persulfate such as potassium persulfate with a tertiary amine, thiourea, or the like. The solvent for use in solution polymerization is not particularly limited, and known solvents that are usually used in polymerization can be used. In particular, in the case of a solvent-based acrylic polymer, the solvent can be selected according to the application. Specific examples include toluene, ethyl acetate, and the like. The dispersant for use in dispersion polymerization is not particularly limited, and known dispersants can be used. The emulsifier for use in emulsion polymerization is not particularly limited, and known anionic emulsifiers, nonionic emulsifiers, and like emulsifiers that are usually used in emulsion polymerization can be used.

The amount of optical embrittlement inhibitor used in the acrylic polymer adhesive composition of the present invention is preferably in the range of about 2 to about 40 parts by weight relative to 100 parts by weight of acrylic polymer. In particular, the amount is preferably in the range of 5 to 20 parts by weight. An amount between 2 to 40 parts by weight is preferable because an optical embrittlement inhibitory effect is demonstrated and adhesion performance is favorable. The amount of optical embrittlement inhibitor used when a tackifier is used is not particularly limited, and the amount is preferably about 2 to about 20 parts by weight and more preferably about 2 to about 10 parts by weight relative to 100 parts by weight of acrylic polymer.

The molecular weight of the acrylic polymer is not particularly limited insofar as the acrylic polymer has cohesive force sufficient for the acrylic polymer adhesive composition. Usually, in the case of a solvent-based acrylic polymer, the weight average molecular weight is preferably 150,000 or greater (in terms of polystyrene as measured by gel permeation chromatography) so as to have sufficient cohesive force or like properties.

The cohesive force and the heat resistance of the acrylic polymer adhesive composition can be further enhanced by adding a crosslinking agent such as a polyisocyanate compound, a polyamine compound, a melamine resin, a urea resin, or an epoxy resin. Among these crosslinking agents, it is particularly preferable to use a polyisocyanate compound, and specific examples thereof include 1,6-hexamethylene diisocyanate, tetramethylene diisocyanate, isophorone diisocyanate, xylylene diisocyanate, tolylene diisocyanate, 4,4-diphenylmethane diisocyanate, and various other known compounds. Furthermore, a filler, an antioxidant, a ultraviolet absorber, and the like may be suitably used in the acrylic polymer adhesive composition of the present invention as necessary.

The styrene/conjugated diene block copolymer adhesive composition that is an adhesive composition of the present invention comprises a styrene/conjugated diene block copolymer and the optical embrittlement inhibitor, and if necessary, may contain the tackifier and an oil.

The styrene/conjugated diene block copolymer refers to a block copolymer formed by suitably selecting and copolymerizing a styrene compound such as styrene or methylstyrene and a conjugated diene compound such as butadiene or isoprene according to the intended use. Usually, the weight ratio of styrene/conjugated diene is 10/90 to 50/50. Preferable examples of such block copolymers include SBS block copolymers having a styrene (S)/butadiene (B) weight ratio in the range of 10/90 to 50/50; SIS block copolymers having a styrene (S)/isoprene (I) weight ratio in the range of 10/90 to 30/70; and the like. In addition, the styrene/conjugated diene block copolymer used in the present invention encompasses a block copolymer in which the conjugated diene component of the block copolymer is hydrogenated. Specific hydrogenated examples include styrene/ethylene/butadiene/styrene (SEBS) block copolymers, styrene/ethylene/propylene/styrene (SEPS) block copolymers, and the like.

Examples of oils include plasticized oils such as naphthene oils, paraffin oils, aromatic oils, and the like. In terms of little cohesive force deterioration, naphthene oils and paraffin oils are preferable. Specific examples include naphthene process oils, paraffin process oils, liquefied polybutene, and the like.

Usually, the amount of optical embrittlement inhibitor used in the styrene/conjugated diene block copolymer adhesive composition of the present invention is preferably about 15 to about 210 parts by weight and more preferably about 30 to about 150 parts by weight relative to 100 parts by weight of styrene/conjugated diene block copolymer. When the amount is less than 15 parts by weight, the optical embrittlement inhibitory effect is likely to be insufficient, and when the amount exceeds 210 parts by weight, adhesion performance such as cohesive force is likely to be impaired. Therefore, such amounts are not preferable.

Usually, the amount of tackifier and the amount of oil used are preferably about 15 to about 210 parts by weight for the tackifier and about 4 to about 200 parts by weight for the oil relative to 100 parts by weight of styrene/conjugated diene block copolymer. When the amount of tackifier is less than 15 parts by weight, the melt viscosity of the adhesive composition is likely to be increased, and when the amount exceeds 210 parts by weight, retentivity is likely to be insufficient. Also, when the amount of oil is less than 4 parts by weight, the melt viscosity of the adhesive composition is likely to be increased, and when the amount exceeds 200 parts by weight, retentivity may be insufficient.

Furthermore, additives such as a filler and an antioxidant may be added to the styrene/conjugated diene block copolymer adhesive composition of the present invention if necessary.

The olefin polymer hot-melt adhesive composition that is an adhesive composition of the present invention contains an olefin homopolymer or copolymer and the optical embrittlement inhibitor, and if necessary, may contain the tackifier and a wax.

The olefin homopolymer includes polymers of various olefins. The various olefins are not particularly limited insofar as they are composed of hydrocarbons having a carbon-carbon unsaturated double bond except for a vinyl group and they are polymerizable, and examples include ethylene, propylene, butene, butylene, isoprene, pentene, pentadiene, butadiene, octene, isooctene, hexene and various hexadiene isomers, heptene and various heptadiene isomers; various α-olefins; and cyclopentene, cyclohexene, norbornene, dicyclopentadienyl, and like cyclic olefins.

The olefin copolymer includes copolymers of olefins and monomers that are copolymerizable with olefins, and examples of monomers copolymerizable with olefins include vinyl acetate, methyl (meth)acrylate, ethyl (meth)acrylate, butyl (meth)acrylate, and the like. Specific examples of olefin homopolymers include polyethylene, polypropylene, ethylene/α-olefin copolymers, amorphous atactic polypropylene, and like those that are conventionally used in hot-melt adhesives. Specific examples of olefin copolymers include ionomers (such as salts of ethylene acrylic acid copolymers), ethylene acrylic acid copolymer (EAA), ethylene methacrylic acid copolymer (EMAA), ethylene vinyl acetate copolymer (EVA), ethylene ethyl acrylate copolymer (EEA), ethylene methyl acrylate copolymer (EMA), ethylene methyl methacrylate copolymer (EMMA), and the like. The amounts of vinyl acetate, various (meth)acrylates, and (meth)acrylic acid derivatives contained are usually about 10 to about 45 wt %.

The molecular weight of the olefin polymer is preferably such that the melt index (under measurement conditions of a temperature of 190° C., a load of 2160 g, and a duration of 10 minutes) is about 10 to about 400 g/10 min.

As for the wax, those that are usable in hot-melt adhesives can be used, and specific examples include petroleum waxes such as paraffin wax and microcrystalline wax; and synthesized waxes such as Fischer-Tropsch wax and low molecular weight polyethylene wax.

Usually, the amount of optical embrittlement inhibitor used in the olefin polymer hot-melt adhesive composition of the present invention is preferably about 50 to about 150 parts by weight and more preferably about 70 to about 130 parts by weight relative to 100 parts by weight of olefin copolymer. When the amount is less than 50 parts by weight, the optical embrittlement inhibitory effect is likely to be insufficient, and when the amount exceeds 150 parts by weight, adhesion performance such as cohesive force is likely to be impaired. Therefore, such amounts are not preferable.

Usually, the amount of tackifier and the amount of wax used are preferably about 50 to about 150 parts by weight for the tackifier and about 10 to about 100 parts by weight for the wax relative to 100 parts by weight of olefin polymer. When the amount of tackifier is 50 parts by weight or greater, sufficient adhesion is obtained, when the amount exceeds 150 parts by weight, sufficient retentivity may not be obtained. When the amount of wax is less than 10 parts by weight, the melt viscosity of the obtained adhesive composition is likely to be excessively high, and when the amount exceeds 100 parts by weight, sufficient retentivity may not be obtained.

Furthermore, additives such as a filler and an antioxidant may be added to the olefin polymer hot-melt adhesive composition of the present invention as necessary.

Thermoplastic Resin Composition

In the thermoplastic resin composition of the present invention, the aforementioned melt fluidity and adhesion improver that is the thermoplastic resin modifier of the present invention is blended with a thermoplastic resin. The thermoplastic resin composition is not particularly limited, and examples include thermoplastic vinyl resin compositions, thermoplastic olefin resin compositions, thermoplastic polycarbonate resin compositions, thermoplastic polyester resin compositions, and the like.

Usually, the amount of thermoplastic resin modifier contained in the thermoplastic resin composition of the present invention is preferably about 0.1 to about 50 parts by weight and more preferably about 0.5 to about 30 parts by weight relative to 100 parts by weight of thermoplastic resin. When the amount is greater than about 0.1 parts by weight, modification effects on, for example, melt fluidity and adhesion are demonstrated, and when the amount is less than about 50 parts by weight, the intrinsic properties of the thermoplastic resin are not impaired.

The thermoplastic resin in the thermoplastic resin composition of the present invention is preferably one or more resins selected from the group consisting of thermoplastic vinyl resins, thermoplastic olefin resins, thermoplastic polycarbonate resins, and thermoplastic polyester resins. That is, these thermoplastic resins are preferable in that they have excellent transparency and heat resistance and with which the effects of the present invention can be sufficiently demonstrated.

Examples of the thermoplastic vinyl resins include homopolymers composed of a single vinyl monomeric component; copolymers in which two or more vinyl monomeric components are combined; copolymers that are composed of a vinyl monomeric component and another polymerizable monomer and contain the vinyl monomeric component in an amount of 50 wt % or greater; polymers of vinyl monomeric components, modified with polymers of conjugated diene compounds such as butadiene, isoprene and chloroprene, or with various rubber components such as natural rubber; and the like.

The vinyl monomeric component is not particularly limited insofar as it is a polymerizable component that has a vinyl group except for olefin, which is composed solely of a hydrocarbon, and examples include styrene, vinyltoluene, α-methylstyrene, α-methyl-p-methylstyrene, ethylstyrene, isobutylstyrene, t-butylstyrene, bromostyrene, chlorostyrene, indene, and like aromatic vinyls; (meth)acrylic acid; methyl (meth)acrylate, ethyl (meth)acrylate, butyl (meth)acrylate, isobutyl (meth)acrylate, 2-ethylhexyl (meth)acrylate, and like (meth)acrylic acid alkyl esters; (meth)acrylonitrile and like vinyl/cyano compounds; 2-hydroxyethyl (meth)acrylate and like hydroxyl group-containing unsaturated compounds; acrylamide compounds; vinyl acetate, vinyl propionate; and the like.

The weight average molecular weight of the thermoplastic vinyl resin is not particularly limited and usually it is preferably about 50,000 to about 600,000 and more preferably about 100,000 to about 500,000. When the weight average molecular weight is within these ranges, the strength and other characteristics of the thermoplastic resin composition is sufficiently demonstrated, and excellent melt fluidity, molding processability, and other properties can be obtained due to the addition of the thermoplastic resin modifier of the present invention.

The thermoplastic vinyl resin can be usually prepared according to known methods such as emulsion polymerization, suspension polymerization, bulk polymerization, solution polymerization, and the like.

Examples of the thermoplastic olefin resins include olefin homopolymers in which various olefins are polymerized and olefin copolymers in which olefins and copolymerizable monomers are copolymerized and in which the amount of olefin is 50 wt % or greater.

The various olefins are not particularly limited insofar as they are composed of hydrocarbons having a carbon-carbon unsaturated double bond except for a vinyl group and are polymerizable, and examples include ethylene, propylene, butene, butylene, isoprene, pentene, pentadiene, butadiene, octene, isooctene, hexene, and various hexadiene isomers, heptene and various heptadiene isomers; various α-olefins; and cyclopentene, cyclohexene, norbornene, dicyclopentadienyl, and like cyclic olefins.

Examples of monomers copolymerizable with the olefins include vinyl acetate, methyl (meth)acrylate, ethyl (meth)acrylate, butyl (meth)acrylate, and the like.

Examples of the olefin copolymers include ionomers (such as salts of ethylene acrylic acid copolymers), ethylene acrylic acid copolymer (EAA), ethylene methacrylic acid copolymer (EMAA), ethylene vinyl acetate copolymer (EVA), ethylene ethyl acrylate copolymer (EEA), ethylene methyl acrylate copolymer (EMA), ethylene methyl methacrylate copolymer (EMMA), and the like. The amounts of vinyl acetate, various (meth)acrylates, and (meth)acrylic acid derivatives are usually about 10 to about 50 wt %.

The thermoplastic polycarbonate resins are not particularly limited and known resins can be used therefor. Specifically, for example, usable are resins that can be obtained by a method in which an aromatic dihydroxy compound and an aliphatic dihydroxy compound are copolymerized by a transesterification reaction in the presence of a transesterification catalyst using a carbonic acid diester as a carbonate source; resins that can be obtained by reacting an aromatic dihydroxy compound and phosgene; and the like. The thermoplastic polycarbonate resins may or may not have a branched structure.

In the transesterification process, a carbonic acid diester is used as a carbonate source. Examples of carbonic acid diesters include diphenyl carbonate, ditolyl carbonate, bis(chlorophenyl)carbonate, m-cresyl carbonate, dinaphthyl carbonate, dim ethyl carbonate, diethyl carbonate, dibutyl carbonate, dicyclohexyl carbonate, and the like. Among these examples, diphenyl carbonate is particularly preferable. The amount of chlorine, which can cause coloring, contained in diphenyl carbonate is preferably 20 ppm or less and more preferably 10 ppm or less. Diphenyl carbonate is preferably used in an amount of 0.97 to 1.2 mol and particularly preferably 0.99 to 1.10 mol per mole of aromatic dihydroxy compound and aliphatic dihydroxy compound combined.

Examples of the aromatic dihydroxy compound include bisphenol A, tetrabromobisphenol A, bis(4-hydroxyphenyl)methane, 1,1-bis(4-hydroxyphenyl)ethane, 2,2-bis(4-hydroxyphenyl)butane, 2,2-bis(4-hydroxyphenyl)octane, 2,2-bis(4-hydroxy-3-methylphenyl)propane, 1,1-bis(3-t-butyl-4-hydroxyphenyl)propane, 2,2-bis(4-hydroxy-3,5-dimethylphenyl)propane, 2,2-bis(3-bromo-4-hydroxyphenyl)propane, 2,2-bis(3,5-dichloro-4-hydroxyphenyl)propane, 2,2-bis(3-phenyl-4-hydroxyphenyl)propane, 2,2-bis(3-cyclohexyl-4-hydroxyphenyl)propane, 1,1-bis(4-hydroxyphenyl)-1-phenylethane, bis(4-hydroxyphenyl)diphenylmethane, and like bis(hydroxyaryl)alkanes; bisphenol Z, 1,1-bis(4-hydroxyphenyl)cyclopentane, 1,1-bis(4-hydroxyphenyl)-3,3,5-trimethylcyclohexane, and like bis(hydroxyaryl)cycloalkanes; 4,4′-dihydroxydiphenyl ether, 4,4′-dihydroxy-3,3′-dimethyldiphenyl ether, and like dihydroxydiaryl ethers; 4,4′-dihydroxydiphenyl sulfide, 4,4′-dihydroxy-3,3′-dimethyldiphenylsulfide, and like dihydroxydiaryl sulfides; 4,4′-dihydroxydiphenyl sulfoxide, 4,4′-dihydroxy-3,3′-dimethyldiphenyl sulfoxide, and like dihydroxydiaryl sulfoxides; 4,4′-dihydroxydiphenyl sulfone, 4,4′-dihydroxy-3,3′-dimethyldiphenyl sulfone, and like dihydroxydiaryl sulfones; hydroquinone, resorcin, 4,4′-dihydroxydiphenyl; and the like. Among these examples, 2,2-bis(4-hydroxyphenyl)propane, 1,1-bis(4-hydroxyphenyl)cyclohexane, and the like are particularly preferable. Aromatic dihydroxy compounds may be used singly or as a combination of two or more.

As for the catalyst for use in the transesterification process, known catalysts are suitably used. Examples include basic compounds, transesterification catalysts, and the like. In particular, alkali metal compounds, alkaline earth metal compounds, nitrogen-containing metallic compounds, tin compounds, and like metallic compounds are suitably used.

The weight average molecular weight of the thermoplastic polycarbonate resin obtained according the foregoing method is preferably about 20,000 to about 200,000 and more preferably about 30,000 to about 120,000.

The thermoplastic polyester resin may be obtained by subjecting a dicarboxylic acid and a diol to an esterification reaction or a transesterification reaction and then carrying out a polymerization reaction. The dicarboxylic acid used to formulate a thermoplastic polyester resin is not particularly limited, and terephthalic acid is particularly preferable because it is inexpensive and the resulting thermoplastic polyester resin exhibit excellent mechanical properties. Examples of dicarboxylic acids other than terephthalic acid include isophthalic acid, 2,6-naphthalene dicarboxylic acid, diphenyldicarboxylic acid, diphenoxyethane dicarboxylic acid, and like aromatic dicarboxylic acids; adipic acid, sebacic acid, azelaic acid, decanedicarboxylic acid, and like aliphatic dicarboxylic acids; cyclohexanedicarboxylic acid and like alicyclic dicarboxylic acids; and the like. Among these examples, isophthalic acid is preferably used. The aforementioned dicarboxylic acids may be used singly or as a combination of two or more.

The diol used to formulate a thermoplastic polyester resin is not particularly limited, and ethylene glycol is particularly preferable because it is inexpensive and the resulting thermoplastic polyester resin exhibits excellent heat resistance. Examples of diols other than ethylene glycol include diethylene glycol, trimethylene glycol, tetramethylene glycol, neopentyl glycol, hexamethylene glycol, dodecamethyleneglycol, triethylene glycol, tetraethylene glycol, polyethylene glycol, and like aliphatic glycols; cyclohexanedimethanol and like alicyclic glycols; 1,3-propanediol, 1,4-butanediol, and like aliphatic diols; bisphenols, hydroquinone, 2,2-bis(4-β-hydroxyethoxyphenyl)propane, and like aromatic diols; and the like. Among these examples, diethylene glycol, 1,4-butanediol, 1,4-cyclohexanedimethanol, and 2,2-bis(4-β-hydroxyethoxyphenyl)propane are preferably used. The aforementioned diols may be used singly or as a combination of two or more.

It is preferable that the thermoplastic polyester resin obtained according to the method described above preferably has a number average molecular weight of about 12,000 or greater. When the number average molecular weight is less than about 12,000, the heat resistance or other properties of the obtained thermoplastic polyester resin may be impaired. From a practical viewpoint, it is more preferable that the number average molecular weight of the thermoplastic polyester resin is about 15,000 to about 30,000.

In addition to the thermoplastic resin and the modifier of the present invention, various known additives such as antioxidants, ultraviolet absorbers, pigments, dyes, reinforcements, fillers, lubricants, mold release agents, crystal nucleating agents, plasticizers, fluidity improvers, and antistatic agents can be suitably added to the thermoplastic resin composition of the present invention. Examples of the antioxidants include sulfur-containing acidic compounds and derivatives formed from such acidic compounds, phenol stabilizers, phosphorus antioxidants, thioether stabilizers, hindered amine stabilizers, epoxy stabilizers, and the like. Examples of the ultraviolet absorbers include benzotriazole ultraviolet absorbers, triazine ultraviolet absorbers, and the like.

### EXAMPLES

The present invention will now be described in more detail below by way of examples, comparative examples, production examples, application examples, and comparative application examples. However, the present invention is not limited to these examples. In the examples, “%” and “parts” refer to “wt %” and “parts by weight”, respectively, unless specified otherwise.

In the examples and comparative examples below, with regard to the resin modifier of the present invention, the component having a molecular weight of 320 of the methylation product of the hydrolysate of a hydrogenated rosin ester as measured by gas chromatography-mass spectrometry was quantified as follows.

A test resin modifier was dissolved in n-hexanol, potassium hydroxide was added to the solution to carrying out a reaction under reflux for 2 hours, and the solution was neutralized with hydrochloric acid for hydrolyzation. The obtained hydrolyzate resin acid was quantified using gas chromatography-mass spectrometry (GC/MS) apparatus. For this measurement, 0.1 g of resin acid was dissolved in 2.0 g of n-hexanol, 0.1 g of this solution and 0.4 g of an on-column methylating agent (a 0.2 mol methanol solution of phenyltrimethylammonium hydroxide (PTHA), manufactured by GL Sciences, Inc.) was homogenously mixed, 1 μl of the mixture was injected into the GC/MS apparatus, and a measurement was carried out. The ratio of the peak area of the component having a molecular weight of 320 to the total peak area of the components having a molecular weight of 314 to 320 was measured, and this was regarded as the amount of the component having a molecular weight of 320.

The GC/MS apparatus used was as follows:

Gas chromatograph: “Agilent 6890” (trade name, manufactured by Agilent Technologies, Inc.)

Mass spectrometer: “Agilent 5973” (trade name, manufactured by Agilent Technologies, Inc.)

Column: “Advance-DS” (trade name, manufactured by Shinwa Chemical Industries Ltd.)

### Production of Resin Modifiers

### Example 1

### Production of Resin Modifier I

200 g of a hydrogenated rosin manufactured in China (a tetrahydroabietic acid content of 17%), 3 g of 5% palladium alumina powder (manufactured by N.E. Chemcat Corporation), and 200 g of cyclohexane were charged into a 1 liter autoclave, oxygen present in the system was removed, a hydrogenation reaction was carried out at 200° C. for 4 hours in a high-pressure hydrogen atmosphere with a hydrogenation pressure of 9 MPa, the solvent was separated by filtration, and cyclohexane was removed under reduced pressure, thus giving 189 g of a hydrogenated rosin having an acid value of 174 mg KOH/g and a softening point of 79° C. (this corresponds to the aforementioned component (a1)). Then, 180 g of the hydrogenated rosin was charge into a reactor equipped with a stirrer, a condenser tube and a nitrogen introducing tube and melted by being heated to 200° C., 21 g of glycerol was charged, and a reaction was carried out at 280° C. for 10 hours, thus giving 175 g of an esterification product of the hydrogenated rosin.

170 g of the hydrogenated rosin ester, 1 g of 5% palladium carbon (a water content of 50%), and 170 g of cyclohexane were charged into a 1 liter autoclave, oxygen present in the system was removed, a hydrogenation reaction was carried out at 200° C. for 4 hours in a high-pressure hydrogen atmosphere with a hydrogenation pressure of 9 MPa, the solvent was separated by filtration, and cyclohexane was removed under reduced pressure, thus giving 164 g of a hydrogenated rosin ester that is the resin modifier I of the present invention. The component having a molecular weight of 320 of the methylation product of the hydrolysate as measured by gas chromatography-mass spectrometry accounted for 100% of the total amount of the components having a molecular weight of 314 to 320. The obtained hydrogenated rosin ester that is the resin modifier I of the present invention had a softening point of 90° C. and a weight average molecular weight of 680.

### Example 2

### Production of Resin Modifier II

200 g of a hydrogenated rosin manufactured in China (a tetrahydroabietic acid content of 17%), 4 g of 5% palladium carbon (a water content of 50%, manufactured by N.E. Chemcat Corporation), and 200 g of cyclohexane were charged into a 1 liter autoclave, oxygen present in the system was removed, a hydrogenation reaction was carried out at 200° C. for 3 hours in a high-pressure hydrogen atmosphere with a hydrogenation pressure of 9 MPa, the solvent was separated by filtration, and cyclohexane was removed under reduced pressure, thus giving 190 g of a hydrogenated rosin having an acid value of 172 mg KOH/g and a softening point of 79° C. (this corresponds to the aforementioned component (a1)). Then, 180 g of the hydrogenated rosin was charge into a reactor equipped with a stirrer, a condenser tube and a nitrogen introducing tube and melted by being heated to 200° C., 21 g of glycerol was charged, and a reaction was carried out at 280° C. for 10 hours, thus giving 172 g of an esterification product having a softening point of 91° C. and an acid value of 9 mg KOH/g of the hydrogenated rosin.

170 g of the hydrogenated rosin ester, 1 g of 5% palladium carbon (a water content of 50%), and 170 g of cyclohexane were charged into a 1 liter autoclave, oxygen present in the system was removed, a hydrogenation reaction was carried out at 200° C. for 4 hours in a high-pressure hydrogen atmosphere with a hydrogenation pressure of 9 MPa, the solvent was separated by filtration, and cyclohexane was removed under reduced pressure, thus giving 163 g of a hydrogenated rosin ester that is the resin modifier II of the present invention. The component having a molecular weight of 320 of the methylation product of the hydrolysate as measured by gas chromatography-mass spectrometry accounted for 96% of the total amount of the components having a molecular weight of 314 to 320. The obtained hydrogenated rosin ester that is the resin modifier II of the present invention had a softening point of 89° C. and a weight average molecular weight of was 670.

### Comparative Example 1

### Production of Resin Modifier III

200 g of a gum rosin, 2 g of 5% palladium carbon (a water content of 50%, manufactured by N.E. Chemcat Corporation), and 100 g of cyclohexane were charged into a 1 liter autoclave, oxygen present in the system was removed, a hydrogenation reaction was carried out at 200° C. for 1.5 hours in a high-pressure hydrogen atmosphere with a hydrogenation pressure of 8 MPa, the solvent was separated by filtration, and cyclohexane was removed under reduced pressure, thus giving 188 g of a hydrogenated rosin having an acid value of 172 mg KOH/g and a softening point of 80° C. (this corresponds to the aforementioned component (a2)). Then, 180 g of the hydrogenated rosin was charge into a reactor equipped with a stirrer, a condenser tube, and a nitrogen introducing tube and melted by being heating to 200° C., 21 g of glycerol was charged, and a reaction was carried out at 280° C. for 10 hours, thus giving 172 g of an esterification product having a softening point of 91° C. and an acid value of 9 mg KOH/g of the hydrogenated rosin.

170 g of the hydrogenated rosin ester obtained above, 1 g of 5% palladium carbon (a water content of 50%), and 170 g of cyclohexane were charged into a 1 liter autoclave, oxygen present in the system was removed, a hydrogenation reaction was carried out at 200° C. for 4 hours in a high-pressure hydrogen atmosphere with a hydrogenation pressure of 9 MPa, the solvent was separated by filtration, and cyclohexane was removed under reduced pressure, thus giving 160 g of a comparative resin modifier III having an acid value of 8 mg KOH/g. The component having a molecular weight of 320 of the methylation product of the hydrolysate as measured by gas chromatography-mass spectrometry accounted for 90% of the total amount of the components having a molecular weight of 314 to 320. The obtained hydrogenated rosin ester that is the comparative resin modifier III had a softening point of 91° C. and a weight average molecular weight of 680.

### Comparative Example 2

### Production of Resin Modifier IV

300 g of rosin was charge into a reactor equipped with a stirrer, a condenser tube and a nitrogen introducing tube and melted by being heated to 200° C., 33 g of glycerol was charged, and a reaction was carried out at 280° C. for 12 hours, thus giving 299 g of a rosin ester having a softening point of 93° C. and an acid value of 6 mg KOH/g.

250 g of the rosin ester obtained above and 10 g of 5% palladium carbon (a water content of 50%) were charged into a 1 liter autoclave, oxygen present in the system was removed, a hydrogenation reaction was carried out at 290° C. for 3 hours in a high-pressure hydrogen atmosphere with a hydrogenation pressure of 9 MPa, and the solvent was separated by filtration, thus giving 243 g of a comparative rosin modifier IV having an acid value of 9 mg KOH/g. The component having a molecular weight of 320 of the methylation product of the hydrolysate as measured by gas chromatography-mass spectrometry accounted for 60% of the total amount of the components having a molecular weight of 314 to 320. The obtained hydrogenated rosin ester that is the comparative resin modifier IV had a softening point of 89° C. and a weight average molecular weight thereof was 690.

### PRODUCTION EXAMPLES, APPLICATION EXAMPLES, AND COMPARATIVE APPLICATION EXAMPLES FOR ADHESIVE COMPOSITIONS

### Production Example 1

### Production of Acrylic Polymer (1)

50 parts of ethyl acetate was charged into a reactor equipped with a stirrer, a condenser tube, 2 dropping funnels, and a nitrogen introducing tube, and then the temperature within the system was increased to about 75° C. in a nitrogen stream. Thereafter, 48.5 parts of butyl acrylate, 48.5 parts of 2-ethylhexyl acrylate, and 3 parts of acrylic acid charged into one dropping funnel in advance as well as 0.1 parts of azobisisobutyronitrile and 30 parts of ethyl acetate charged into the other dropping funnel in advance were added dropwise to the system over about 2 hours, and that temperature was maintained for 5 hours to complete a polymerization reaction. Ethyl acetate was further added so as to attain a solid content of about 50%, thus giving an ethyl acetate solution containing an acrylic polymer (1).

### Production Example 2

### Production of Acrylic Polymer (2)

An ethyl acetate solution containing an acrylic polymer (2) was obtained in the same manner as in Production Example 1 except that the acrylic monomers used were 68.0 parts of butyl acrylate, 29 parts of 2-ethylhexyl acrylate, and 3 parts of acrylic acid and the amount of azobisisobutyronitrile was 0.07 parts.

### Production of Adhesive Compositions

### Application Example 1

10 parts of a tackifier (trade name “KE-311”, manufactured by Arakawa Chemical Industries, Ltd.) and 10 parts of the resin modifier I obtained in Example 1 that is an optical embrittlement inhibitor of the present invention were added to 80 parts (solid content weight) of the acrylic polymer (1) obtained in Production Example 1, and 2 parts of a polyisocyanate compound (trade name “Coronate L”, manufactured by Nippon Polyurethane Industry Co., Ltd.) was added as a crosslinking agent, thus giving a solvent-based acrylic polymer adhesive composition. The obtained solvent-based acrylic polymer adhesive composition was applied to a polyester film having a thickness of about 38 μm using a cubic applicator so as to attain a dry thickness of about 30 μm (an application width of 25 mm), the solvent in the adhesive composition varnish was air-dried, and the film was dried in an air-circulation dryer at 105° C. for 5 minutes to give a sample tape that was then left to stand under 23° C., 65% R.H. conditions for 1 week.

### Application Examples 2 to 9 and Comparative Application Examples 1 to 8

Sample tapes were prepared in the same manner as in Application Example 1 except that the component formulations used were as shown in Table 1, and then the tapes were left to stand under 23° C., 65% R.H. conditions for 1 week.

The component formulations of the solvent-based acrylic polymer adhesive compositions obtained in Application Examples 1 to 9 and Comparative Application Examples 1 to 8 are shown in Table 1. The amounts in the table refer to solid contents in part by weight.

TABLE 1

| | | Acrylic | | | | | | Resin | | |
|---|---|---|---|---|---|---|---|---|---|---|
| | | polymer | | Tackifier | | | | modifier | | Ultraviolet |
| | | (1) | (2) | (1) | (2) | (3) | (4) | I | II | absorber |
| Application | 1 | 80 | | 10 | | | | 10 | | |
| example | 2 | 80 | | 10 | | | | | 10 | |
| | 3 | 80 | | 10 | | | | 10 | | 0.5 |
| | 4 | 80 | | | | | | 20 | | |
| | 5 | 80 | | | 10 | | | 10 | | |
| | 6 | 80 | | | | 10 | | 10 | | |
| | 7 | 80 | | | | | 10 | 10 | | |
| | 8 | | 80 | 10 | | | | 10 | | |
| | 9 | | 80 | | 10 | | | 10 | | |
| Comparative | 1 | 90 | | 10 | | | | | | |
| application | 2 | 80 | | 20 | | | | | | |
| example | 3 | 80 | | | 20 | | | | | |
| | 4 | 80 | | | | 20 | | | | |
| | 5 | 80 | | | | | 20 | | | |
| | 6 | 80 | | 20 | | | | | | 0.5 |
| | 7 | 80 | | 20 | | | | | | 5 |
| | 8 | 100 | | | | | | | | |

In Table 1, the tackifiers (1) to (4) and the ultraviolet absorber used were as follows:

Tackifier (1): Hydrogenated rosin ester (trade name “KE-311”, the component having a molecular weight of 320 of the methylation product of the hydrolysate as measured by gas chromatography-mass spectrometry accounting for 20% of the total amount of the components having a molecular weight of 314 to 320, manufactured by Arakawa Chemical Industries, Ltd.)

Tackifier (2): Disproportionated rosin ester (trade name “Super Ester A-100”, the component having a molecular weight of 320 of the methylation product of the hydrolysate as measured by gas chromatography-mass spectrometry accounting for 0% of the total amount of the components having a molecular weight of 314 to 320, manufactured by Arakawa Chemical Industries, Ltd.)

Tackifier (3): Polymerized rosin ester (trade name “Pensel D-125”, manufactured by Arakawa Chemical Industries, Ltd.)

Tackifier (4): Hydroxyl group-containing hydrogenated petroleum resin (trade name “KR-1840”, manufactured by Arakawa Chemical Industries, Ltd.)

Ultraviolet absorber: “Tinuvin P” (trade name, manufactured by Ciba Japan)

Next, the constant-load peelability, transparency, and optical embrittlement resistance of the sample tapes of the adhesive compositions obtained in the application examples and the comparative application examples were evaluated. The evaluation methods are as follows.

Constant-Load Peelability

Each sample tape was pressed against a polyethylene plate that served as a substrate to receive an adhesive over an adhered area of 25 mm×100 mm using a 2 kg rubber roller, the tape and the plate were adhered to each other by applying the 2 kg roller back and forth once, after 30 minutes a load of 50 g was applied to one edge of the tape, the polyethylene plate was securely held such that peeling occurred at a 90° angle, and the distance (mm) of peeling created in one hour was measured in a 23° C. atmosphere.

Transparency

Each sample tape was visually inspected and determined whether or not the tapes were transparent or opaque and white.

Optical Embrittlement Resistance

The optical embrittlement resistance was evaluated by comparing probe tack after irradiating each sample tape with light in a cumulative amount of 200 J/cm² and 300 J/cm² using a high-pressure mercury lamp (a wavelength of 295 to 450 nm) with probe tack before irradiation using an “NS probe tack tester” (trade name, manufactured by Nichiban Co., Ltd., a load of 100 g/cm², a dwell time of 1 second). The results are presented with pre- and post-irradiation probe tack values (g/5 mmφ).

The results of performance evaluation are shown in Table 2 below.

TABLE 2

| | | | | Optical embrittlement resistance (g/5 mmφ) | | |
|---|---|---|---|---|---|---|
| | | | | | After | After |
| | | Constant-load | | Before | irradiation of | irradiation of |
| | | peelability (mm) | Transparency | irradiation | 200 J/cm² | 300 J/cm² |
| Application | 1 | 12.8 | Transparent | 780 | 650 | 560 |
| example | 2 | 11.5 | Transparent | 790 | 650 | 540 |
| | 3 | 10.8 | Transparent | 810 | 670 | 590 |
| | 4 | 8.5 | Transparent | 850 | 810 | 810 |
| | 5 | 10.5 | Transparent | 790 | 580 | 410 |
| | 6 | 5.8 | Transparent | 870 | 590 | 400 |
| | 7 | 15.7 | Transparent | 720 | 510 | 370 |
| | 8 | 12.4 | Opaque and | 640 | 560 | 450 |
| | | | white | | | |
| | 9 | 6.8 | Transparent | 710 | 560 | 450 |
| Comparative | 1 | 29.8 | Transparent | 650 | 470 | 340 |
| application | 2 | 11.8 | Transparent | 800 | 380 | 50 |
| example | 3 | 11.9 | Transparent | 810 | 310 | 30 |
| | 4 | 4.2 | Opaque and | 830 | 320 | 20 |
| | | | white | | | |
| | 5 | 17.7 | Transparent | 700 | 650 | 40 |
| | 6 | 11.5 | Transparent | 700 | 470 | 60 |
| | 7 | 21.5 | Transparent | 560 | 490 | 360 |
| | 8 | 83.8 | Transparent | 560 | 520 | 500 |

### PRODUCTION EXAMPLES, APPLICATION EXAMPLES, AND COMPARATIVE APPLICATION EXAMPLES FOR THERMOPLASTIC RESIN COMPOSITIONS

### Production Example 3

### Preparation of Adhesive Tapes for Adhesion Evaluation

An aqueous solution composed of 43.4 parts of water and 0.92 parts of a polyoxyethylene alkyl ether sulfate sodium salt (anionic emulsifier, trade name “Hitenor 073”, manufactured by Dai-Ichi Kogyo Seiyaku Co., Ltd.) were charged into a reaction vessel equipped with a stirrer, a thermometer, a reflux condenser tube, a dropping funnel, and a nitrogen introducing tube in a nitrogen gas stream, and heated to 70° C. Then, a mixture composed of 90 parts of butyl acrylate, 7 parts of 2-ethylhexyl acrylate and 3 parts of acrylic acid as well as an aqueous initiator solution composed of 0.24 parts of potassium persulfate (polymerization initiator), 0.11 parts of a pH adjustor (sodium bicarbonate) and 8.83 parts of water were added to the reaction vessel in an amount 1/10th of the total amount of the mixture and the aqueous initiator solution, and a prepolymerization reaction was carried out at 70° C. for 30 minutes in a nitrogen gas stream. Next, the remaining 9/10th amount of the mixture and the aqueous initiator solution were added to the reaction vessel over 2 hours to carry out emulsion polymerization and then the reaction vessel was retained at 70° C. for 1 hour to complete the polymerization reaction. The acrylic polymer emulsion thus obtained was cooled to room temperature and filtered with a 100-mesh metal screen, thus giving an emulsion adhesive having a solid content of 47.8%.

The emulsion adhesive was applied to a PET film having a thickness of 38 μm so as to attain a coating thickness of 100 μm and a coating width of 25 mm and dried at 105° C. for 5 minutes, thus giving an adhesive tape for adhesion evaluation having a coating thickness of 30 μm.

### Production Example 4

### Production of Thermoplastic Olefin Resin (2)

Under a nitrogen atmosphere, 3.5 liter of dehydrated toluene, 1.5 liter of dehydrated methyltetracyclododecene, and 0.1 liter of dehydrated 1-hexene were introduced into a dried 10 liter reactor, 0.225 mol of triethylaluminium, 0.675 mol of triethylamine, and 0.045 mol of titanium tetrachloride were introduced, and a reaction was carried out at room temperature for 1 hour. The reaction was terminated with a mixed solution of isopropyl alcohol and aqueous ammonia, the reaction product was solidified with large amounts Of isopropyl alcohol, dried at 60° C. for an entire day, thus giving a thermoplastic olefin resin (2).

### Production Example 5

### Production of Thermoplastic Vinyl Resin (3)

50 parts of ethyl acetate was charged into a reactor equipped with a stirrer, a cooling tube, 2 dropping funnels, and a nitrogen introducing tube, and then the temperature within the system was increased to about 75° C. in a nitrogen stream. Thereafter, 48.5 parts of butyl acrylate, 48.5 parts of 2-ethylhexyl acrylate, and 3 parts of acrylic acid charged into one dropping funnel in advance as well as 0.1 parts of azobisisobutyronitrile and 30 parts of ethyl acetate charged into another dropping funnel in advance were added dropwise to the system over about 2 hours, and that temperature was maintained for 5 hours to complete a polymerization reaction, and 20 parts of butyl acetate was added, thus giving a 50% ethyl acetate solution of a thermoplastic vinyl resin (3).

### Production of Thermoplastic Resin Compositions

### Application Example 10

5 parts by weight of the resin modifier I (a melt fluidity and adhesion improver) obtained in Example 1 and 95 parts by weight of a thermoplastic vinyl resin (1) (trade name “Acrypet MD”, manufactured by Mitsubishi Rayon Co., Ltd.) were mixed by stirring for 3 minutes. The mixture was melt-mixed at a temperature of 200 to 280° C. using a twin screw extrusion molding machine (trade name “PLABOR BT-30-L”, manufactured by Research Laboratory of Plastics Technology Co., Ltd.) and pellets of a thermoplastic vinyl resin composition were obtained according to the strand-cut method. With the pellets thus obtained, a test molded plate having a length×width×thickness of 150 mm×50 mm×2 mm was produced using an injection molding machine (trade name “JSW-J75EII P”, manufactured by Japan Steel Works Ltd.).

### Application Examples 11 and 14 to 17 and Comparative Application Examples 9 to 18, 24 to 45, and 47 to 50

Pellets of thermoplastic resin compositions were obtained in the same manner as in Application Example 10 except that the resin modifiers and the thermoplastic resins shown in Tables 3 and 4 were used. With the pellets thus obtained, test molded plates having a length×width×thickness of 150 mm×50 mm×2 mm were produced in the same manner as in Application Example 10.

### Application Example 12

10 parts by weight of the resin modifier I (a melt fluidity and adhesion improver) obtained in Example 1 and 90 parts by weight (solid content weight) of the thermoplastic vinyl resin (3) obtained in Production Example 5 were mixed, applied to a PET film having a thickness of 38 μm using a 200 μm applicator, and dried, thus giving a thermoplastic vinyl resin composition test sheet having a thickness of 60 μm.

### Application Example 13 and Comparative Application Examples 19 to 23 and 46

Thermoplastic resin composition test sheets having a thickness of 60 μm were obtained in the same manner as in Application Example 12 except that the resin modifiers and the thermoplastic resins shown in Tables 3 and 4 were used.

The component formulations of the thermoplastic resin compositions obtained in Application Examples 10 to 17 and Comparative Application Examples 9 to 50 are shown in Tables 3 and 4. The amounts in the tables refer to solid contents in part by weight.

TABLE 3

| | | Thermoplastic | | | Thermoplastic | | Thermoplastic | Thermoplastic | | | | | | | |
|---|---|---|---|---|---|---|---|---|---|---|---|---|---|---|---|
| | | vinyl resin | | | olefin resin | | polycarbonate | polyester | Resin modifier | | | | Tackifier | | |
| | | (1) | (2) | (3) | (1) | (2) | resin | resin | I | II | III | IV | (1) | (2) | (5) |
| Application | 10 | 95 | | | | | | | 5 | | | | | | |
| Example | 11 | | 90 | | | | | | 10 | | | | | | |
| | 12 | | | 90 | | | | | 10 | | | | | | |
| | 13 | | | 90 | | | | | | 10 | | | | | |
| | 14 | | | | 90 | | | | 10 | | | | | | |
| | 15 | | | | | 90 | | | 10 | | | | | | |
| | 16 | | | | | | 95 | | 5 | | | | | | |
| | 17 | | | | | | | 95 | 5 | | | | | | |
| Comparative | 9 | 95 | | | | | | | | | 5 | | | | |
| Application | 10 | 95 | | | | | | | | | | 5 | | | |
| Example | 11 | 95 | | | | | | | | | | | 5 | | |
| | 12 | 95 | | | | | | | | | | | | 5 | |
| | 13 | 95 | | | | | | | | | | | | | 5 |
| | 14 | | 90 | | | | | | | | 10 | | | | |
| | 15 | | 90 | | | | | | | | | 10 | | | |
| | 16 | | 90 | | | | | | | | | | 10 | | |
| | 17 | | 90 | | | | | | | | | | | 10 | |
| | 18 | | 90 | | | | | | | | | | | | 10 |
| | 19 | | | 90 | | | | | | | 10 | | | | |
| | 20 | | | 90 | | | | | | | | 10 | | | |
| | 21 | | | 90 | | | | | | | | | 10 | | |
| | 22 | | | 90 | | | | | | | | | | 10 | |
| | 23 | | | 90 | | | | | | | | | | | 10 |
| | 24 | | | | 90 | | | | | | 10 | | | | |
| | 25 | | | | 90 | | | | | | | 10 | | | |

TABLE 4

| | | Thermoplastic | | | Thermoplastic | | Thermoplastic | Thermoplastic | | | | | | | |
|---|---|---|---|---|---|---|---|---|---|---|---|---|---|---|---|
| | | vinyl resin | | | olefin resin | | polycarbonate | polyester | Resin modifier | | | | Tackifier | | |
| | | (1) | (2) | (3) | (1) | (2) | resin | resin | I | II | III | IV | (1) | (2) | (5) |
| Comparative | 26 | | | | 90 | | | | | | | | 10 | | |
| Application | 27 | | | | 90 | | | | | | | | | 10 | |
| Example | 28 | | | | 90 | | | | | | | | | | 10 |
| | 29 | | | | | 90 | | | | | 10 | | | | |
| | 30 | | | | | 90 | | | | | | 10 | | | |
| | 31 | | | | | 90 | | | | | | | 10 | | |
| | 32 | | | | | 90 | | | | | | | | 10 | |
| | 33 | | | | | 90 | | | | | | | | | 10 |
| | 34 | | | | | | 95 | | | | 5 | | | | |
| | 35 | | | | | | 95 | | | | | 5 | | | |
| | 36 | | | | | | 95 | | | | | | 5 | | |
| | 37 | | | | | | 95 | | | | | | | 5 | |
| | 38 | | | | | | 95 | | | | | | | | 5 |
| | 39 | | | | | | | 95 | | | 5 | | | | |
| | 40 | | | | | | | 95 | | | | 5 | | | |
| | 41 | | | | | | | 95 | | | | | 5 | | |
| | 42 | | | | | | | 95 | | | | | | 5 | |
| | 43 | | | | | | | 95 | | | | | | | 5 |
| | 44 | 100 | | | | | | | | | | | | | |
| | 45 | | 100 | | | | | | | | | | | | |
| | 46 | | | 100 | | | | | | | | | | | |
| | 47 | | | | 100 | | | | | | | | | | |
| | 48 | | | | | 100 | | | | | | | | | |
| | 49 | | | | | | 100 | | | | | | | | |
| | 50 | | | | | | | 100 | | | | | | | |

In Tables 3 and 4, the thermoplastic resins and the tackifiers used are as follows:

Thermoplastic vinyl resin (1): “Acrypet MD” (trade name, manufactured by Mitsubishi Rayon Co., Ltd.)

Thermoplastic vinyl resin (2): “Styron 666” (trade name, manufactured by Asahi Kasei Corporation)

Thermoplastic vinyl resin (3): Production Example 5

Thermoplastic olefin resin (1): “F203T” (trade name, manufactured by Japan Polypropylene Corporation)

Thermoplastic olefin resin (2): Production Example 4

Thermoplastic polycarbonate resin: “Iupiron S-2000” (trade name, manufactured by Mitsubishi Engineering-Plastics Corporation)

Thermoplastic polyester resin: “Toraycon 1401X06” (trade name, Toray Industries, Inc.)

Tackifier (1): Hydrogenated rosin ester (trade name “KE-311”, the component having a molecular weight of 320 of the methylation product of the hydrolysate as measured by gas chromatography-mass spectrometry accounting for 20% of the total amount of the components having a molecular weight of 314 to 320, manufactured by Arakawa Chemical Industries, Ltd.)

Tackifier (2): Disproportionated rosin ester (trade name “Super Ester A-100”, the component having a molecular weight of 320 of the methylation product of the hydrolysate as measured by gas chromatography-mass spectrometry accounting for 0% of the total amount of the components having a molecular weight of 314 to 320, manufactured by Arakawa Chemical Industries, Ltd.)

Tackifier (5): Hydrogenated petroleum resin (trade name “Arkon P-100”, manufactured by Arakawa Chemical Industries, Ltd.)

Next, the initial color, transparency, light resistance, melt fluidity, and adhesion of the test molded plates and the test sheets of the thermoplastic resin compositions obtained in the application examples and the comparative application examples were evaluated. The evaluation methods are as follows.

Initial Color

The obtained test molded plates and the test sheets were visually inspected, and the initial color of the molded plates and the sheets were evaluated based on the following criteria:

A: No color deterioration occurred compared with a test molded plate or sheet obtained solely from a thermoplastic resin.

B: More coloring, such as yellowing, was observed than in a molded plate or sheet obtained solely from a thermoplastic resin.

Transparency

The obtained test molded plates and the test sheets were visually inspected and were evaluated as to whether the molded plates and the sheets were transparent or opaque.

Light Resistance

The obtained test molded plates and the test sheets were irradiated with light in a cumulative amount of 1,200 J/cm² using a high-pressure mercury lamp (a wavelength of 295 to 450 nm). The molded plates and the sheets were visually inspected before and after irradiation for coloring, such as yellowing, and the color thereof was evaluated based on the following criteria:

A: No coloring was observed compared with a molded plate or sheet obtained solely from a thermoplastic resin.

B: Slightly more coloring was observed than in a molded plate or sheet obtained solely from a thermoplastic resin.

C: Significantly more coloring was observed than in a molded plate or sheet obtained solely from a thermoplastic resin.

Melt Fluidity

Pellets of the obtained thermoplastic resins were injection-molded using an injection molding machine (trade name “JSW-J75EII P”, manufactured by Japan Steel Works Ltd.) at a pressure of 1,000 kgf/cm², and the lengths (cm) of the injected resins were measured. The metal mold used was a metal mold for Archimedes spiral flow measurement having a channel width of 10 mm and a channel thickness of 2 mm, and the mold temperature was 80° C. Measurements were carried out at a resin temperature of 210° C. for the thermoplastic vinyl resin (1), at a resin temperature of 190° C. for the thermoplastic vinyl resin (2), at a resin temperature of 210° C. for the thermoplastic olefin resin (1), at a resin temperature of 280° C. for the thermoplastic olefin resin (2) and for the thermoplastic polycarbonate resin, and at a resin temperature of 250° C. for the thermoplastic polyester resin. The resins of Application Examples 12 and 13 and Comparative Application Examples 19 to 23 and 46 exhibited a certain level of fluidity at room temperature and thus were not evaluated.

Adhesion

The adhesion of the obtained test molded plates and the test sheets were measured as follows. For the test molded plates, the adhesive tape for adhesion evaluation obtained in Production Example 3 was pressed against each plate over an adhered area of 25 mm×125 mm using a 2 kg rubber roller, and the plates were left to stand at 20° C. for 24 hours. Thereafter, a 180° peeling test was performed at a peeling rate of 300 mm/min at 20° C. using a Tensilon tensile tester to measure adhesive strength over 25 mm width (g/25 mm). Also, for the test sheets, each sheet was pressed against a polyethylene plate over an adhered area of 25 mm×125 mm using a 2 kg rubber roller, and the sheets were left to stand at 20° C. for 24 hours. Thereafter, a 180° peeling test was performed at a peeling rate of 300 mm/min at 20° C. using a Tensilon tensile tester to measure adhesive strength over 25 mm width (g/25 mm).

The results of performance evaluation are shown in Tables 5 and 6.

TABLE 5

| | | Initial | | Light | Melt | Adhesion |
|---|---|---|---|---|---|---|
| | | color | Transparency | resistance | fluidity (cm) | (g/cm²) |
| Application | 10 | A | Transparent | A | 22.8 | 1020 |
| Example | 11 | A | Transparent | A | 25.8 | 980 |
| | 12 | A | Transparent | A | — | 570 |
| | 13 | A | Transparent | A | — | 580 |
| | 14 | A | Transparent | A | 31.2 | 490 |
| | 15 | A | Transparent | A | 13.5 | 470 |
| | 16 | A | Transparent | A | 10.1 | 820 |
| | 17 | A | Transparent | A | 13.2 | 1060 |
| Comparative | 9 | A | Transparent | B | 22.1 | 1040 |
| Application | 10 | A | Transparent | B | 21.9 | 1050 |
| Example | 11 | A | Transparent | C | 22.2 | 990 |
| | 12 | B | Transparent | C | 22.0 | 1010 |
| | 13 | A | Opaque | B | 21.1 | 980 |
| | 14 | A | Transparent | B | 26.0 | 990 |
| | 15 | A | Transparent | B | 26.0 | 960 |
| | 16 | A | Transparent | C | 26.7 | 980 |
| | 17 | B | Transparent | C | 26.8 | 970 |
| | 18 | A | Opaque | B | 23.0 | 920 |
| | 19 | A | Transparent | B | — | 590 |
| | 20 | A | Transparent | B | — | 560 |
| | 21 | A | Transparent | C | — | 610 |
| | 22 | B | Transparent | C | — | 600 |
| | 23 | A | Opaque | B | — | 310 |
| | 24 | A | Transparent | B | 30.2 | 480 |
| | 25 | A | Transparent | B | 30.7 | 500 |

TABLE 6

| | | Initial | | Light | Melt | Adhesion |
|---|---|---|---|---|---|---|
| | | color | Transparency | resistance | fluidity (cm) | (g/cm²) |
| Comparative | 26 | A | Transparent | C | 31.0 | 490 |
| Application | 27 | B | Transparent | C | 30.9 | 460 |
| Example | 28 | A | Transparent | B | 31.1 | 520 |
| | 29 | A | Transparent | B | 13.2 | 490 |
| | 30 | A | Transparent | B | 13.0 | 500 |
| | 31 | A | Transparent | C | 13.3 | 500 |
| | 32 | B | Transparent | C | 12.9 | 520 |
| | 33 | A | Transparent | B | 13.7 | 550 |
| | 34 | A | Transparent | B | 10.0 | 860 |
| | 35 | A | Transparent | B | 10.2 | 850 |
| | 36 | A | Transparent | C | 9.8 | 860 |
| | 37 | B | Transparent | C | 9.8 | 800 |
| | 38 | A | Opaque | B | 9.2 | 770 |
| | 39 | A | Transparent | B | 13.0 | 1040 |
| | 40 | A | Transparent | B | 13.3 | 1000 |
| | 41 | A | Transparent | C | 13.3 | 1020 |
| | 42 | B | Transparent | C | 12.9 | 1020 |
| | 43 | A | Opaque | B | 11.3 | 990 |
| | 44 | Regarded | Transparent | Regarded | 19.0 | 890 |
| | 45 | as standard | Transparent | as standard | 20.0 | 860 |
| | 46 | | Transparent | | — | 280 |
| | 47 | | Transparent | | 25.0 | 250 |
| | 48 | | Transparent | | 9.3 | 210 |
| | 49 | | Transparent | | 7.1 | 730 |
| | 50 | | Transparent | | 10.3 | 980 |

### INDUSTRIAL APPLICABILITY

The optical embrittlement inhibitor, which is the resin modifier of the present invention, can be preferably used as a modifier that imparts excellent light resistance over time to an adhesive composition to which a low molecular weight resin is added. Moreover, since the optical embrittlement inhibitor also has an adhesion improving effect, the optical embrittlement inhibitor can be preferably used as a modifier for an adhesive composition to which no low molecular weight resin is added. Furthermore, since the optical embrittlement inhibitor improves adhesion while maintaining the excellent light resisting properties of an acrylic polymer, the optical embrittlement inhibitor can be used particularly preferably as a modifier for an acrylic polymer adhesive composition.

The melt fluidity and adhesion improver, which is the thermoplastic resin modifier of the present invention, can be preferably used as a modifier for a thermoplastic resin used in applications where light resistance is required over time. Specifically, it can be preferably used as a modifier for thermoplastic vinyl resins, thermoplastic olefin resins, thermoplastic polycarbonate resins, thermoplastic polyester resins, and the like.

1. A resin modifier comprising as an active ingredient a hydrogenated rosin ester in which a component having a molecular weight of 320 of a methylation product of a hydrolyzate of the hydrogenated rosin ester as measured by gas chromatography-mass spectrometry accounts for 95 wt % or greater of a total amount of components having a molecular weight of 314 to 320.

2. The resin modifier according to claim 1, wherein the hydrogenated rosin ester has a softening point of 60° C. to 120° C.

3. The resin modifier according to claim 1, wherein the hydrogenated rosin ester has a weight average molecular weight of 500 to 2,000.

4. The resin modifier according to claim 1, being an optical embrittlement inhibitor for an adhesive polymer resin.

5. The resin modifier according to claim 1, being a melt fluidity and adhesion improver for a thermoplastic resin.

6. An adhesive composition comprising a polymer resin and an optical embrittlement inhibitor of claim 4.

7. The adhesive composition according to claim 6, wherein the polymer resin is at least one resin selected from the group consisting of acrylic polymers, styrene/conjugated diene block copolymers, and olefin polymers.

8. The adhesive composition according to claim 7, wherein the polymer resin is an acrylic polymer.

9. The adhesive composition according to claim 6, wherein the optical embrittlement inhibitor is used in an amount of 2 to 210 parts by weight relative to 100 parts by weight of the polymer resin.

10. The adhesive composition according to claim 6, further comprising a tackifier.

11. The adhesive composition according to claim 10, wherein the tackifier is an esterified product of a hydrogenated rosin comprising 20 to 91 wt % of tetrahydroabietic acid.

12. The adhesive composition according to claim 10, wherein the optical embrittlement inhibitor is used in an amount of 20 to 500 parts by weight relative to 100 parts by weight of the tackifier.

13. A thermoplastic resin composition comprising a thermoplastic resin and a melt fluidity and adhesion improver of claim 5.

14. The thermoplastic resin composition according to claim 13, wherein the thermoplastic resin is at least one resin selected from the group consisting of thermoplastic vinyl resins, thermoplastic olefin resins, thermoplastic polycarbonate resins, and thermoplastic polyester resins.

15. The thermoplastic resin composition according to claim 13, wherein the melt fluidity and adhesion improver is used in an amount of 0.1 to 50 parts by weight relative to 100 parts by weight of the thermoplastic resin.
